(19) United States
(12) Patent Application Publication
(10) Pub. No.: US 2024/0278680 A1
(43) Pub. Date: Aug. 22, 2024

(54) BATTERY SWAPPING SYSTEM AND METHOD OF OPERATION THEREOF

(71) Applicant: Pravaig Dynamics Private Limited, Delhi (IN)

(72) Inventors: Dhawal KHULLAR, Jaipur (IN); Siddhartha BAGRI, New Delhi (IN)

(21) Appl. No.: 18/569,699

(22) PCT Filed: Apr. 19, 2022
(86) PCT No.: PCT/IB2022/053629

§ 371 Date: Dec. 13, 2023

(30) Foreign Application Priority Data
Jun. 14, 2021 (IN) 202141026366

(51) Int. Cl. B60L 53/80

(52) U.S. Cl. CPC B60L 53/80; B60L 2240/62

(57) ABSTRACT

An electric vehicle 700 battery swapping system 500, comprising a platform 100 with slots 610 on batteries 600 and arms 50 equipped with pins 58 along the platform's length l; a plurality of wheels 30 disposed on an outer surface of the platform 100; a lifting mechanism 40 attached to the fixed end 52 to toggle the at least one arm 50 between an upper configuration 42 and a downward configuration 44; an alignment system 300 having a plurality of camera 315 disposed onto the platform 100 and a plurality of alignment marker 310 disposed onto a chassis 760 of the vehicle 700; a positioning system 400 provided in the platform 100 connected to a central server 450 located remotely. A battery swap method 2000 includes removing a depleted battery 600′ and inserting a recharged battery 600 using the system 500.

### FIELD OF INVENTION

The present invention relates to a battery swapping system and more particularly relates to a system for exchanging discharged batteries with charged batteries for electric vehicles.

### BACKGROUND OF THE INVENTION

Electric vehicles are utilized as a substitute to combustion-engine vehicles reducing the consumption of fossil fuels. An electric or hybrid vehicle having at least one electric traction motor includes a battery pack or other electrochemical cells providing propulsion energy for motor. The problem related to electric vehicles is the amount of time taken for the battery to get charged. Thus, battery changing station for replacement of discharged battery with charged battery to replenish power in the vehicle is becoming more and more prominent.

In the known art, significant contributions have been made on the battery installation and removal system for electric vehicles. WO2020/089935A1 discloses one such system and method for battery exchange using autonomous mobile robots that includes a battery rack system, a battery exchange server, autonomous mobile robots (AMR) and a battery collection and delivery system. The AMR includes a guide mechanism i.e. a pair of guide rails disposed onto an upper surface of the base member for mounting and movably connecting the battery collection and delivery system. The battery exchanging system as per this document utilizes complex mechanical parts to raise and lower the battery that may lead to misbalancing of battery at the time of locking or releasing of the battery to chassis of the vehicle.

The patent document U.S. Pat. No. 9,688,252 by Gaffoglio et al relates to a battery swapping system and techniques for electric vehicle that includes a guided roller for correct positioning of the vehicle, an inboard lift for raising the vehicle to a predetermined height, and a battery lift. The battery swapping system as per this document has the following disadvantages: (1) requirement of a large area for building the battery swapping system; (2) automation system and infrastructure are expensive; and (3) need skilful individuals for handling the said system.

The patent document US2016036846 by Hassounah relates to a robot assisted modular battery interchanging system that includes a mobile operations platform 130 and robot 120. The mobile operation platform 130 is responsible for storage of charged batteries and for exchanging discharged batteries with charged batteries. A portable robotic unit is utilised for battery removal and replacement. The portable robotic unit includes a battery interface 260, an elevation trellis 250 and a main body 220. It needs to be understood that the ground clearance in electric vehicle is less. Thus, a platform having a scissor jack is not feasible.

The patent document U.S. Pat. No. 9,358,895 by Avganim relates to a quick loading and unloading battery system for vehicles. In the present patent document, the electric vehicle has a battery placed from the top. The system uses a forklift having two lifting arms. Thus, this system can only be utilised for electric cars having battery placement from the above.

The best way of utilisation of electric car for longer journey is battery replacement instead of battery charging. The existing battery replacement stations are fully automatic, taking up a lot of space, requires infrastructure, is expensive, and requires cars to be parked in certain direction in order to carry out the battery swapping. The present invention aims to avoid, or at least ameliorate the drawbacks of the prior art.

### OBJECTIVE OF THE INVENTION

A primary object of the present invention is to develop a system for battery swapping in manually and autonomously driven electric vehicles of any type, using either an autonomous robot or that requires human assistance.

Another object of the embodiments of the present invention is to provide a system for battery swapping without a need for precision parking of vehicle.

Another object of the present invention is to provide a system for battery swapping that positions itself with respect to the vehicle rather than positioning the electric vehicle with precision.

Another object of the present invention is to provide an integration and removal system which does not require special tools like screwdrivers, nuts, bolts etc. for installation and removal of batteries.

Yet another object of the present invention is to provide a system for battery swapping that provides an integrated hollow rectangular platform to accumulate the battery with an eminent grip.

Yet another object of the present invention is to provide a locking mechanism in the system to lock the arms provided on a platform with the battery.

Yet another object of the present invention is to provide an alignment system that includes cameras to detect markers on the chassis of vehicles so as to enable alignment of the platform with the vehicle for easy installation and removal of batteries.

Yet another object of the present invention is to provide a lifting mechanism in the system to enable longitudinal movement of the platform for swapping discharged batteries with charged ones.

Yet another object of the present invention is to provide a system for battery swapping that provides a simple yet effective way of battery exchange.

Yet another object of the present invention is to provide a cost-effective, flexible and dynamically scalable system for battery swapping without additional cost of expensive infrastructure or installation.

### SUMMARY OF THE INVENTION

The present disclosure provides a battery swapping system compatible with electric or extended-range electric vehicles. The battery swapping system can be autonomous or one which is operated by a human. The battery swapping system of the present invention does not require additional cost with respect to space and infrastructure. The battery swapping system for a vehicle as per present invention allows exchange of discharged battery with a fully charged battery. The discharged battery includes partially drained or completely drained battery. The system includes a plurality of platforms having a depth to receive and carry a battery; at least a pair of slots disposed on the battery; and a plurality of alignment markers disposed onto a chassis of the vehicle.

A method of swapping a discharged battery with a charged battery as per the present invention broadly includes removal of a discharged battery from a vehicle and insertion of a fully recharged battery into the vehicle using the battery swapping system. The method of removal of the discharged battery from the vehicle using the battery swapping system further includes recognizing and navigating a platform to the electric vehicle using the positioning system; aligning the platform with a bottom chassis of the electric vehicle using an alignment system; and positioning the discharged battery from a battery bay to a rectangular hollow region of the platform using a lifting mechanism. The method of insertion of a fully recharged battery into the vehicle further includes recognizing and navigating of a platform having a fully recharged battery to the vehicle aligning of the platform with the bottom chassis of the electric vehicle using an alignment system; lifting the battery from the platform towards the battery bay using the lifting mechanism; and engagement of the battery into the battery bay of the vehicle.

### BRIEF DESCRIPTION OF DRAWINGS

FIG. 1 illustrates a system for swapping discharged batteries with charged batteries in vehicle.

FIG. 2A illustrates a perspective view of a platform of the battery swapping system.

FIG. 2B illustrates a perspective view of the battery placed in a depth d of the platform of the battery swapping system. FIG. 2C illustrates a perspective view of the battery raised by the arms away from the platform.

FIG. 3 illustrates a top view of an arm with a fixed end connected to a lifting mechanism and a free end having a pin.

FIG. 4 illustrates a perspective view of the platform with a plurality of arms toggling between an upward configuration and a downward configuration.

FIG. 5 illustrates perspective view of a battery having a plurality of slots along its length.

FIG. 6 illustrates a top view of a chassis of the vehicle with a plurality of alignment markers.

FIG. 7A illustrates a perspective view of an automatic platform of the system equipped with a plurality of camera, and an ultrasonic proximity sensor. FIG. 7B illustrates a perspective view of the automatic platform having a worm gear and a spur gear attached to a servo motor, a microcontroller powered by a power pack.

FIG. 8A illustrates a perspective view of a semi-automatic platform of the system equipped with a plurality of camera, a rod having a screen with a control panel; a handle. FIG. 8B illustrates a perspective view of the semi-automatic platform having each of the pair of arms, a link, a shaft, a hydraulic ram, a hydraulic plumbing, a pump and a power pack.

FIG. 9A illustrates a perspective view of a manual platform of the system equipped with a plurality of mirror, a handle, and a hand pump. FIG. 9B illustrates a perspective view of the manual platform having each of the pair of arms, a link, a shaft, a hydraulic ram, a common pipe and the hand pump.

FIG. 10 illustrates a flow chart of a method of exchanging discharged battery with fully charged battery.

### DETAILED DESCRIPTION OF EMBODIMENTS

As used in the specification and claims, the singular forms “a”, “an” and “the” include plural references unless the context clearly dictates otherwise. For example, the term “an article” may include a plurality of articles unless the context clearly dictates otherwise.

There may be additional components described in the foregoing application that are not depicted on one of the described drawings. In the event such a component is described, but not depicted in a drawing, the absence of such a drawing should not be considered as an omission of such design from the specification.

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

The term “batteries” as used herein should be understood in a broad sense encompassing replaceable electrical energy providing modules of any kind whether commonly denominated “batteries”, “storage cells,” or some other nomenclature. Further, the terms battery or battery modules or battery packs may be used interchangeably.

Further, spatially relative terms, such as “beneath”, “below”, “lower”, “above”, “upper” and the similar, utilized herein for description of one element(s) or feature(s) relationship to other element(s) or feature(s) illustrated in the figures of the present invention. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

The present disclosure provides a battery swapping system 500 compatible with electric or extended-range electric vehicles. The battery swapping system 500 can be an autonomous robot or semi-automatic or operated by a human. The battery swapping system 500 of the present invention does not require additional cost with respect to space and infrastructure.

FIG. 1 shows a schematic representation of the battery swapping system 500 (hereinafter referred to as “system”) for a vehicle 700 allowing exchange of discharged battery with fully charged battery, as it appears. The discharged battery includes one or more of a partially drained or completely drained battery. The system 500 comprises a platform 100 having a depth d to receive a battery 600; at least a pair of slots 610 disposed on the battery 600; and a plurality of alignment markers 310 disposed onto a chassis 760 of the vehicle 700.

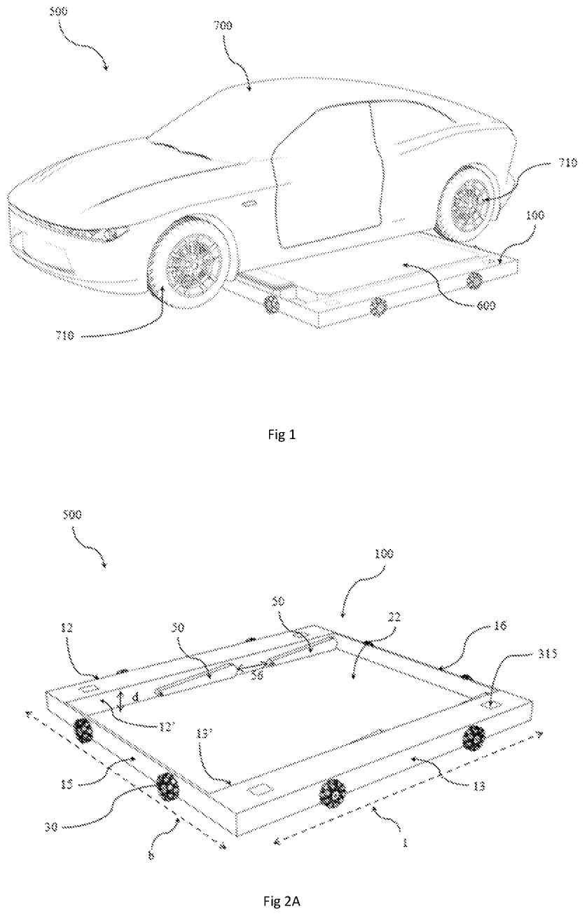

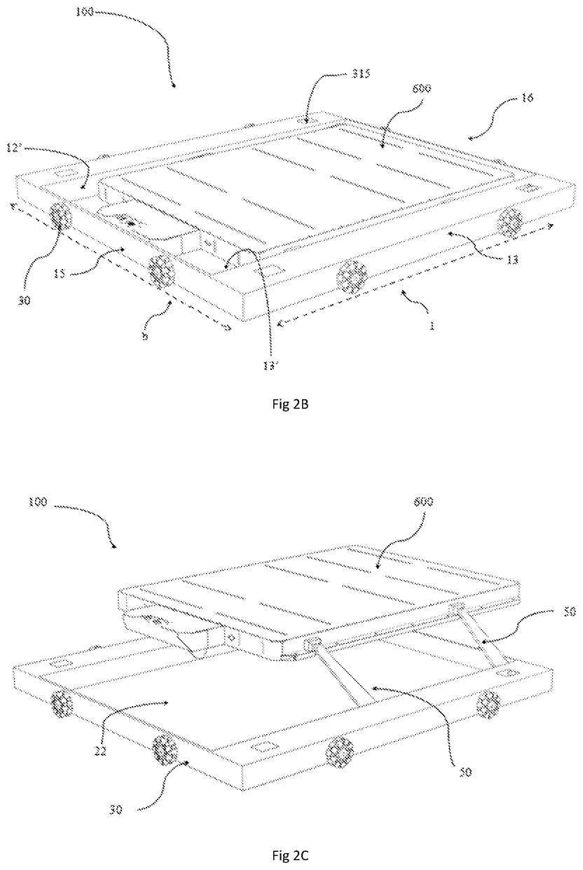

Referring to the FIGS. 2A-2C, the platform 100 has a base 10 (not shown in the figure), a first wall 12 and a second wall 13 associated with a length l of the base 10 and a third wall 15 and a fourth wall 16 associated with a breadth b of the base 10. As shown in FIGS. 2A & 2B, a hollow rectangular region 22 is formed between an inner first wall 12′ and an inner second wall 13′ having the depth d for receiving the battery 600 in the platform 100. The hollow rectangular region 22 has a dimension in consonance with a dimension of a battery 600.

An internal space 20 is provided between the inner first wall 12′ and the first wall 12 and an inner second wall 13′ and the second wall 13 along the length l of the platform 100. Further, the internal space 20 is concealed, as shown in FIG. 2A-2C. As shown in FIG. 1, the platform 100 has a dimension D such that the platform 100 fits underneath the vehicle 700 between side wheels 710 of the vehicle 700. The platform 100 is made of material that is robust to bear weight of the battery 600. The platform 100 could be an autonomous or automatic or a semi-automatic or a manually operated. The dimension of the platform 100 can be adjusted to receive battery 600 of various dimensions as per requirement.

At least a pair of arm 50 i.e. a first arm is disposed on the inner first wall 12′ and a second arm disposed on the inner second wall 13′ of the platform 100. According to FIG. 2A, in a preferred embodiment, a pair of arms 50, each is disposed on the inner first wall 12′ and the inner second wall 13′ along the length l of the platform 100. Further, a fixed gap 56 is maintained between the pair of arms 50, as shown in FIG. 2A. The fixed gap 56 allows a free movement of a first arm of the pair of arms 50 without interfering with the other arm of the pair of arms 50.

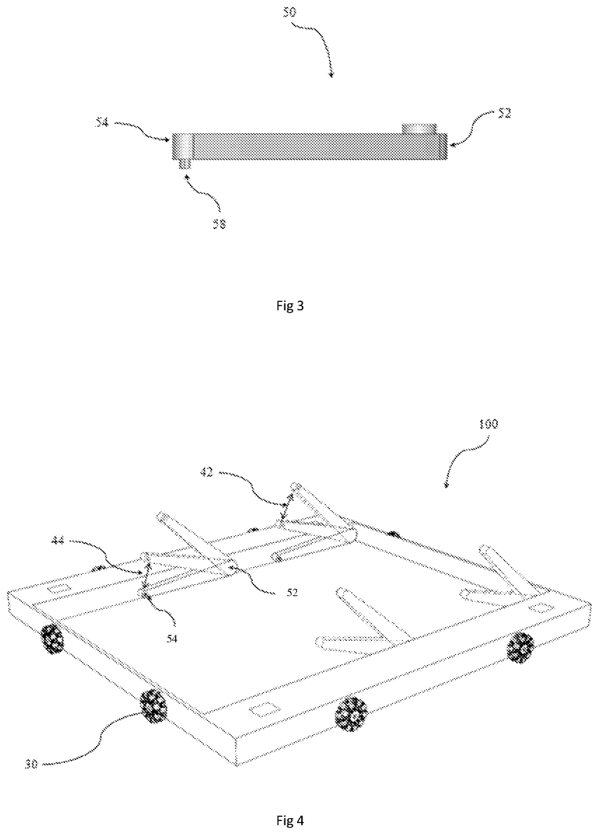

As illustrated in FIG. 3, each arm of the pair of arms 50 has a fixed end 52 and a free end 54. The fixed end 52 is disposed to the inner walls 12′ and 13′ of the platform 100. A pin 58 is disposed on the free end 54 of each arm 50. As shown in FIG. 4, the free end 54 of the arm 50 toggles between an upward configuration 42 and a downward configuration 44. In the downward configuration 44, each arm 50 is parallel to the inner first wall 12′ and the inner second wall 13′ respectively, and in the upward configuration 42, each arm 50 is at an angle with respect to the inner first wall 12′ and the inner second wall 13′. The upward configuration 42 and the downward configuration 44 of the arm 50 are achieved by a lifting mechanism 40.

Referring to FIG. 2A-2C, the lifting mechanism 40 for the arm 50 is disposed within the internal space 20. The fixed end 52 of each arm 50 is connected to the lifting mechanism 40 allowing the free end 54 of the arm 50 to move between the upward configuration 42 and the downward configuration 44. The lifting mechanism 40 employed to achieve the upward configuration 42 and the downward configuration 44 for the pair of arm 50 includes a hydraulic cylinder or an electric actuator or a servo motor. Any other technology in the future to carry similar outcome.

As shown in FIG. 2A-2C, the platform 100 is provided with a plurality of wheels 30. The plurality of wheels 30 are disposed on an outer surface of the first wall 12 and an outer surface of second wall 13 associated with the length l of the base 10 and a third wall 15 and a fourth wall 16 associated with the breadth b of the base 10. In the preferred embodiment, a pair of wheels 30, each disposed on the outer surface of the first wall 12 & the second wall 13 and the third wall 15 & the fourth wall 16 of the platform 100. In the preferred embodiment, the wheels provided are omni-directional. The omni- directional wheels allow the platform 100 to have multiple degrees of freedom, essential to maneuver in tight parking spots. The platform 100 can perform complex maneuvers in limited space, so the installed infrastructure can be denser eliminating need for dedicated pathways. In another embodiment, three wheels 30, each are disposed on the outer surface of the first wall 12 and the second wall 13 associated with a length l of the platform 100.

Referring to FIG. 2C and FIG. 5, at least a pair of slots 610 i.e. a first slot 610a is disposed along a first outer longitudinal surface 604a and a second slot 610b is disposed along a second outer longitudinal surface 604b of the battery 600. In the present embodiment, a pair of slots 610, each is provided on each of the outer longitudinal surface 604a and 604b of the battery 600. As shown in, each pin 58 of the pair of arms 50 engages with the pair of slots 610 provided on each of the longitudinal surface 604a and 604b of the battery 600. Each pin 58 has a dimension in consonance with a dimension of each of the slots 610, so as the pin 58 can securely engage with each of the slots 610 of the battery 600. Thus, the engagement of the pins 58 of the arm 50 into the at least one slot 610 is a crucial in lifting of the battery 600 from the platform 100.

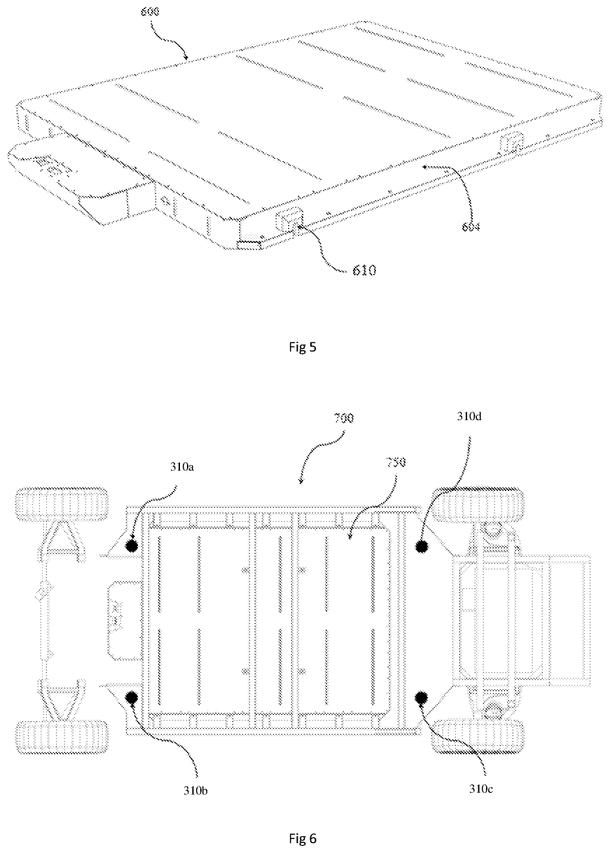

The battery swapping system 500 has the plurality of alignment markers 310 disposed at various positions on a bottom chassis 760 facing ground of the vehicle 700. In the preferred embodiment, as shown in FIG. 6, four alignment markers 310a-d are disposed at four positions on the bottom chassis 760. A first pair of alignment markers 310a and 310b is disposed on a front region 760a of the bottom chassis 760 and a second pair of alignment markers 310c and 310d is disposed on a back region 760b of the bottom chassis 760 of the vehicle 700.

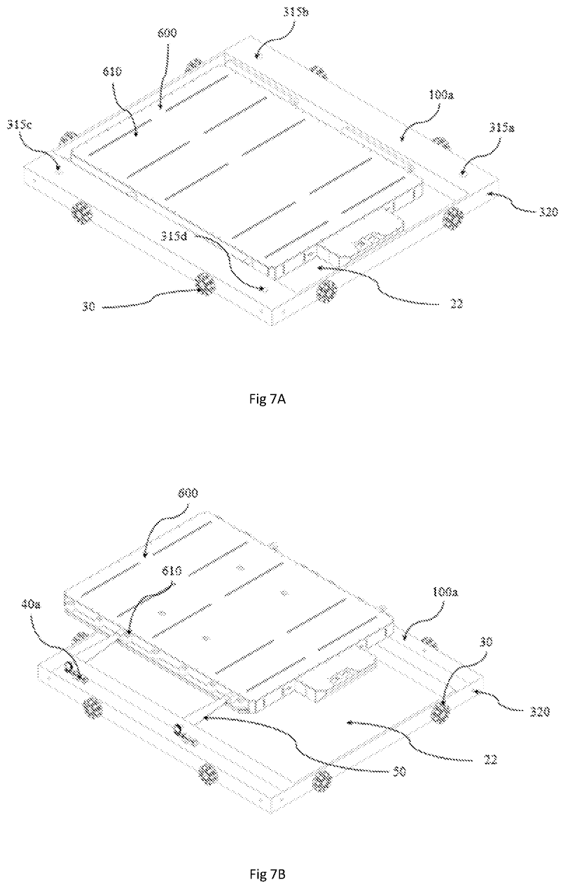

In the preferred embodiment, referring to FIG. 7A and 7B, the platform 100a is automatic or autonomous i.e. the platform 100a is able to maneuver by itself. The platform 100a is further equipped with a plurality of camera 315 disposed onto the platform 100a to detect the plurality of alignment markers 310 for an alignment of platform 100a along the battery bay 750 of the vehicle 700; a positioning system 400 disposed on the platform 100a connected to a central server 450 located remotely to detect a position of the vehicle 700; an ultrasonic proximity sensor 320 disposed on the platform 100a to detect hurdles in a path of movement of the platform 100a; an encoder 51 is disposed in at least a pair of arms 50 for detecting change in weight; a servo motor 31 connected to each of the plurality of wheels 30; and a power pack to provide power to the platform 100a.

The lifting mechanism 40a employed in the platform 100a includes a worm gear and a spur gear attached to a servo motor. Further, a microcontroller is attached to the servo motor. This entire setup is powered by a power pack. This setup of lifting mechanism 40a is individually provided to each arm of the pair of arms 50. The microcontroller controls the toggle of the pair of arms 50 between the upward configuration 42 and the downward configuration 44.

Further, the platform 100a is provided with a plurality of camera 315 disposed on a top surface 102 of the platform 100a. In the preferred embodiment, four cameras 315a-d are disposed on four corners of the top surface 102 of the platform 100a, as shown in FIG. 7A. The four cameras 315a-d provide a view angle of 120 degree. The four cameras 315a-d detect the four-alignment marker 310a-d provided on the bottom chassis 760 of the vehicle 700. The detection of the four-alignment marker 310a-d allows the platform 100a to align with precision along the battery bay 750 of the vehicle 700. A precise alignment of the platform 100a with the battery bay 750 is essential for the engagement of pins 58 of the pair of arms 50 with the pair of slots 610 of the battery 600 for the removal of discharged battery 600 and placement of the fully recharged battery 600′ into the vehicle 700. Each of the pair of arms 50 is provided with the encoder 51. The encoder 51 is able to detect the change in the weight on each of the arms 50. This allows the system 500 to detect the completion of the engagement of each pin 58 of each of the pair of arms 50 with each of the pair of slots 610 of the battery 600, thus allowing the system 500 to perform the next function.

The positioning system 400 (not shown in figure) allows the platform 100a to navigate to the vehicle 700 for removal and replacement of a discharged battery 600 with a fully recharged battery 600′. The positioning system 400 employed in the platform 100a includes a global positioning system (GPS) technology, Bluetooth technology, Wi-Fi technology, an ultra-wideband (UWB) communication technology, an indoor positioning system, a RFID technology to locate a position of the vehicle 700.

Further, the platform 100a is provided with the central server 450 (not shown in figure) of the system 500 is configured for identification, and storage of vehicle information, and battery information, in a database. In the preferred embodiment, the central server 450 provides or identifies a unique code to the vehicle 700. The unique code includes the car registration number and a battery serial number for identification of the vehicle 700. The central server 450 (not shown in the figure) interacts with a battery management system of the vehicle 700. This allows the central server 450 to receive information with regards to status or condition of the battery 600. Further, the central server 450 interacts with the platform 100a through the positioning system 400. The central server 450 sends the unique code and a location of the vehicle 700 to the positioning system 400 for recognition, and navigation of the platform 100a to the vehicle 700. Further, the ultrasonic proximity sensor 320 disposed on the platform 100a. These sensors 410 are used for detection of hurdles during the navigation of the platform 100a. Also, each wheel 30 of the platform 100a is powered by a servo-motor 31 allowing the platform 100a to move around independently. Further, the platform 100a is powered with a power pack 101 carryout all the functions autonomously.

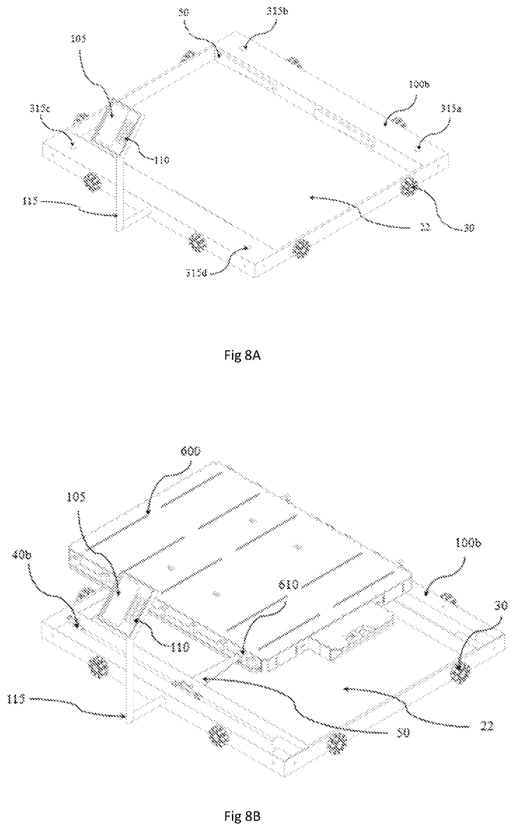

In other embodiment, referring to FIG. 8A and FIG. 8B, the platform 100b is semi-automatic requiring decisions to be made by a user. The platform 100b includes a rod 115 having a screen 105 with a control panel 110; a handle 120 attached to the rod 115 to maneuver the platform 100b; a plurality of camera 315 disposed on the platform 100b; a servo-motor 31 provided to each of the plurality of wheels 30; and a current sensor disposed on each of at least one pair of arms 50. The screen 105 with the control panel 110 is attached to a first end of the rod 115. A second end of the rod 115 is attached to the platform 100b. A handle 120 is disposed along length of the rod 115. The handle 120 is provided for maneuvering the platform 100b by the user to the vehicle 700. A plurality of camera 315 disposed on a top surface 102 of the platform 100b. In the preferred embodiment, four cameras 315a-d is disposed on four corners of the top surface 102 of the platform 100b, as shown in FIG. 7A. The four cameras 315a-d provide a view angle of 120 degree. The four cameras 315a-d are connected to the screen 105 to provide a live stream of video. The user aligns the platform 100b along the battery bay 750 of the vehicle 700 using the plurality of alignment markers 310. Further, the lifting mechanism 40b employed in the platform 100b includes each of the pair of arms 50 connected to a link through a shaft. Each link is further connected to a hydraulic cylinder, which in turn is connected to a hydraulic pump via a flow control valves. As per the present invention and common pump and/or separate valves may be utilized for LHS and RHS rams. This entire setup is powered by a power pack. Each of the pair of arms 50 is toggled between the upper configuration 42 and the downward configuration 44 by the user using control panel 110. This allows the user to either raise the battery 600 towards or away from the battery bay 750 of the vehicle 700. A current sensor 53 are incorporated into each of the pair of arms 50 for sensing engagement and/or disengagement of each of the pin 58 with each of the pair of slots 610 as a result of a change in flow of current as a function of weight. Also, each wheel 30 is powered by a servo-motor 31 allowing the platform 100b to move around by pressing a button 111 provided on the control panel 110 by the user.

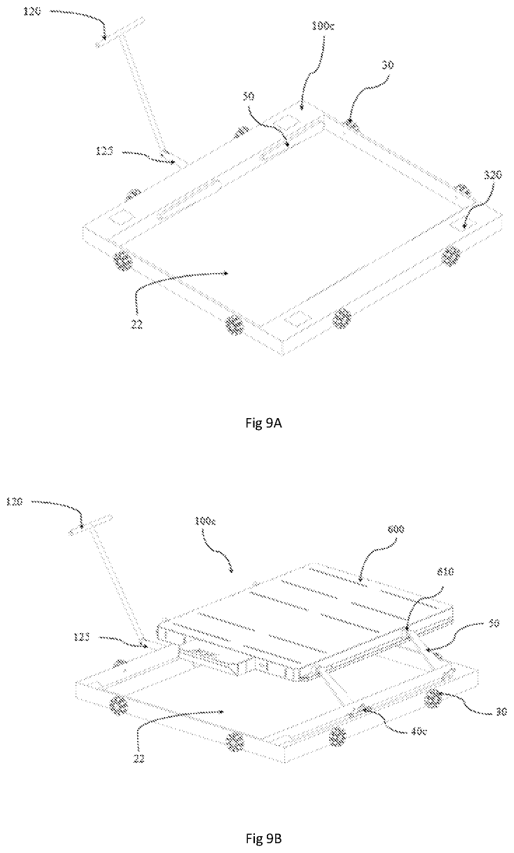

In another embodiment, referring to FIG. 9A-9B, the platform 100c is operated by a user. The platform 100c includes a handle 120 attached the rod 115; a plurality of mirror 320 disposed on the platform 100c; and a pump handle 125 attached to the platform 100c. The rod 115 is attached to the platform 100c through its first end and the handle 120 is attached at a second end of the rod 115b. The handle 120 is provided for the navigating the platform 100c towards the vehicle 700 by the user. The user pushes the platform 100c. Further, the lifting mechanism 40c employed in the platform 100c includes a pair of arms 50 connected to a link through a shaft. Each link is further connected to a hydraulic cylinder in turn connected a common pipe. Further, the common pipe is connected to a hand pump 125. A movement of the hand-pump 125 by the user allows each of the pair of arms 50 to be toggled between the upper configuration 42 and the downward configuration 44. This allows the user to either raise the battery 600 either towards or away from the battery bay 750 of the vehicle 700. The mirrors 320 provided on the platform 100c allow the user to visualize the plurality of alignment markers 310 disposed at various positions on a bottom chassis 760 for alignment of the platform 100c along the battery bay 750 of the vehicle 700.

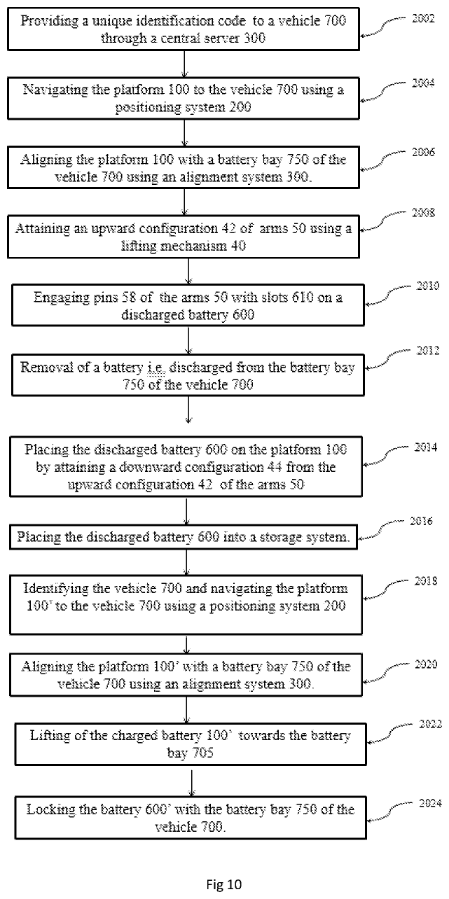

According to FIG. 9, a method 2000 of swapping discharged battery 600 with charged battery 600′ by the system 500 is outlined in FIG. 10. The method 2000 broadly includes a step of removal of a discharged battery from a vehicle 700 and a step of insertion of a fully recharged battery 600′ into the vehicle 700 using the system 500. The method of removal of the discharged battery 600 from the vehicle 700 using the system 500 further includes recognizing and navigating a platform 100 to the vehicle 700; aligning of the platform 100 with a battery bay 750 of the vehicle 700 using a plurality of alignment markers 310; positioning the discharged battery 600a from the battery bay 750 to a rectangular hollow region 22 of the platform 100 using a lifting mechanism 40. The method of insertion of a fully recharged battery 600′ into the vehicle 700 further includes recognizing and navigating of a platform 100 having a battery 600′ i.e. a fully charged to the vehicle 700; aligning of the platform 100 with the bottom chassis 760a of the vehicle 700 using the plurality of alignment marker 310; lifting of the battery 600′ i.e. the fully charged from the platform 100 towards the battery bay 750 using the lifting mechanism 40; securing of the battery 600′ into the battery bay 750 of the vehicle 700.

The method 2000 initiates when the vehicle 700 arrives at a station. The vehicle 700 is identified using either a car registration number and/or a battery serial number (step 2002). The platform 100 is empty. The platform 100 navigates to the vehicle 700 (step 2004). Further, the platform 100 aligns itself under the vehicle 700 by identifying a plurality of alignment markers 310 disposed on a bottom chassis 760 of the vehicle 700. This allows the alignment of the platform 100 with a battery bay 750 of the vehicle 700 (step 2006). Each of two pair of arms 50 provided on an inner first wall 12′ and inner second wall 13′of the platform 100 attain an upward configuration 42 using a lifting mechanism 40 (step 2008). The upward configuration 42 of the two pair of arms 50 leads engagement of each of the pin 58 with each of slot 610 on a battery 600 (step 2010). Thus, the step 2006 of the alignment of the platform 100 with the battery bay 750 the vehicle 700 forms a crucial step in the method 2000 for the exchange of the battery 600 i.e. a discharged battery using the system 500. Following the step 2010, the battery 600 i.e. the discharged battery is removed from the battery bay 750 of the vehicle 700 (step 2012). Thus, the battery 600 released from the battery bay 750 and remains engaged and supported by the pair of arms 50 in the upward configuration 42. The battery 600 i.e. the discharged battery is placed into a rectangular hollow region 22 having a depth d of the platform 100. This is achieved by toggling of the pair of arms 50 along with the battery 600 i.e. the discharged battery from an upward configuration 42 to a downward configuration 44 using the lifting mechanism 40 (step 2014). The platform 100 along with the battery 600 i.e. the discharged battery moves away from the vehicle 700 for a placement of the battery 600 i.e. the discharged battery to a storage system where the battery 600 i.e. the discharged battery is placed for recharging (step 2016).

A second platform 100′ or the same platform 100 identifies and navigates to the vehicle 700 (step 2018). The second platform 100′ or the same platform 100 carries battery 600′ i.e. a fully charged battery placed in a rectangular hollow region 22 having a depth d of the platform 100. The battery 600′ is placed such that a pair of slots 610 is engaged with each pin 58 of each of the pair of arms 50 in the downward configuration 44 of the second platform 100′. The step 2018 is followed with alignment of the second platform 100′ or the same platform 100 with the battery bay 750 of the vehicle 700 by identification of a plurality of alignment markers 310 (step 2020). The step 2020 is followed with the lifting of the battery 600′ i.e. the fully charged battery from the second platform 100′ or the same platform 100 towards the battery bay 750. The lifting of the battery 600′ i.e. the fully charged battery from the rectangular hollow region 22 of the second platform 100′ or the same platform 100 is achieved by a movement of each of the pair of arms 50 from the downward configuration 44 to the upward configuration 42 using the lifting mechanism 40 (step 2022). The step 2022 is followed by mounting of battery 600′ i.e. the fully charged battery with the battery bay 750 of the vehicle 700 (step 2024). This completes the process of placement of the fully charged battery module 600′ into the battery bay 750 of the vehicle 700. The second platform 100′ or the same platform 100 moves away from the vehicle 700.

In a preferred embodiment, a method 2000a of swapping depleted battery 600 with recharged battery 600′of a vehicle 700 using an autonomous or automatic platform 100a includes the following steps as explained below. The autonomous platform is powered by a power pack to carry out all its functions as mentioned below. When the vehicle 700 arrives at a station, a unique code of the vehicle 700 is transmitted through a central server 300 of a battery swapping system 500 to the platform 100a. The unique code includes a car registration number and/or a battery serial number. This step is followed by navigation of the platform 100a to the vehicle 700 using the unique code by a positioning system. During the navigation to the vehicle 700, the platform 100a maneuvers itself using a power pack. Further, the plurality of wheels 30 are provided with servo-motor powered by a power pack for self-maneuvering of the platform 100a. The platform 100a maneuvers using a plurality of ultrasonic proximity sensors 320 for detection of hurdles in the path to the vehicle 700. This is followed by the step of alignment of the platform 100a by detecting a plurality of alignment marker 310 under the vehicle 700. A plurality of camera 315 disposed on the platform 100a are programmed to automatically detect of the plurality of alignment marker 310, thus aligning the platform 100a along the battery bay 750 of the vehicle 700. The precise alignment of the platform 100a is followed by toggling of each of two pair of arms 50 to attain an upward configuration 42 using a lifting mechanism 40. The lifting mechanism 40 implemented is a worm gear and a spur gear attached to a servo motor. Further, a microcontroller is attached to the servo motor powered by a power pack. The microcontroller based on a signal moves each of the pair of arms 50 synchronously towards the battery bay 750 of the vehicle 700. This leads to the engagement of each pin 58 of each of the pair of arms 50 with each of the pair of slots 610 of the battery 600 i.e. the discharged battery. Each of the pair of arms 50 is provided with an encoder. The encoder 51 is able to determine position of arms 50, and weight is sensed by means of current consumption of servo motor detecting the completion of the engagement of each pin 58 of each of the pair of arms 50 with each of the pair of slots 610 of the battery 600 i.e. the discharged battery. This allows the system 500 to carry the step of removal of the battery 600 i.e. the discharged battery from the battery bay 750. This step is followed by the step of placement of the battery 600 i.e. the discharged battery into a rectangular hollow region 22 having a depth d of the platform 100a. This step is achieved by the toggling of each of the pair of arms 50 along with the battery 600 i.e. the discharged battery from the upward configuration 42 to the downward configuration 44 using the lifting mechanism 40. Following the above step, the platform 100a along with the battery 600 i.e. the discharged battery moves away from the vehicle 700 for a placement of the battery 600 i.e. the discharged battery to a storage system where the battery 600 i.e. the discharged battery is placed for charging.

A second platform 100a′ or the same platform 100a with a battery 600′ i.e. a charged battery identifies and navigates to the vehicle 700 by the unique code using the positioning system 400 and the plurality of ultrasonic proximity sensors 320 to the vehicle 700. This is followed by the step of alignment of the second platform 100a′ or the same platform 100a along the battery bay 750 of the vehicle 700. This step includes the platform 100a or 100a′ automatically detecting the plurality of alignment marker 310 using the plurality of camera 315 under the vehicle 700 for a precise alignment. This step is followed by the step of lifting the battery 600′ i.e. fully charged from the depth d of the platform 100a towards the battery bay 750 of the vehicle 700. In this step, each of pin 58 of each of the pair of arms 50 are engaged with each of the pair of slots 610. This step is followed by the step of mounting the battery 600′ fully charged with the battery bay 750 of the vehicle 700. In this step once the battery 600′ i.e. fully charged is mounted into the battery bay, each of the pair of arms 50 are toggled from the upward configuration 42 to the downward configuration 44. This step occurs only when the encoder provided in each of the pair of arms 50 detects a zero weight. In the next step, the platform 100a moves away from the vehicle 700.

In another embodiment, a method 2000b of swapping depleted battery 600 with recharged battery 600′ of a vehicle 700 using a semi-automatic platform 100b includes the following steps as explained below. When the vehicle 700 arrives at a station, a unique code of the vehicle 700 provided to a user having the platform 100b. The unique code includes a car registration number and/or a battery serial number. This step is followed by navigation of the platform 100b by the user to the vehicle 700 using the unique code. The plurality of wheels 30 are provided with servomotor powered by a power pack for maneuvering of the platform 100b under the control of the user. This is followed by the step of alignment of the platform 100b by detecting a plurality of alignment markers 310 under the vehicle 700. A plurality of camera 315 disposed on the platform 100b provides a live stream on a screen 105 having a control panel 110. This helps the user to align the platform 100b manually, thus aligning the platform 100a along the battery bay 750 of the vehicle 700. The precise alignment of the platform 100b by the user is followed by the user toggling of each of two pair of arms 50 to attain an upward configuration 42 using a lifting mechanism 40 using the control panel 110. The lifting mechanism 40b implemented includes a pair of arms 50 connected to a link through a shaft. Each link is further connected to a hydraulic cylinder in turn connected a common pipe and powered by a power pack. The user using the control panel 110 moves each of the pair of arms 50 to attain an upward configuration 42. This leads to the engagement of each pin 58 of each of the pair of arms 50 with each of the pair of slots 610 of the battery 600 i.e. the discharged battery. Each of the pair of arms 50 is provided with a current sensor. The current sensor is able to detect the change in the current in each of the arms 50, detecting the completion of the engagement of each pin 58 of each of the pair of arms 50 with each of the pair of slots 610 of the battery 600 i.e. the discharged battery. This allows the system 500 to carry the step of removal of the battery 600 i.e. the discharged battery from the battery bay 750. This step is followed by the step of placement of the battery 600 i.e. the discharged battery into a rectangular hollow region 22 having a depth d of the platform 100a. This step is achieved by the toggling of each of the pair of arms 50 along with the battery 600 i.e. the discharged battery from the upward configuration 42 to the downward configuration 44 using the lifting mechanism 40. Following the above step, the platform 100b along with the battery 600 i.e. the discharged battery moves away from the vehicle 700 for a placement of the battery 600 i.e. the discharged battery to a storage system where the battery 600 i.e. the discharged battery is placed for charging.

A second platform 100a′ or the same platform 100a with a battery 600′ i.e. a charged battery is navigated by the user to the vehicle 700 using the unique code. This is followed by the step of alignment of the second platform 100a′ or the same platform 100a along the battery bay 750 of the vehicle 700 by the user. This step includes the user visualizing the plurality of alignment markers 310 on the screen 105 using the plurality of camera 315 under the vehicle 700 for a precise alignment with the battery bay 750. This step is followed by the step of lifting the battery 600′ i.e. fully charged from the depth d of the platform 100a towards the battery bay 750 of the vehicle 700 by the user. In this step, each of pin 58 of each of the pair of arms 50 are engaged with each of the pair of slots 610. This step is followed by the step of mounting the battery 600′ fully charged with the battery bay 750 of the vehicle 700. In this step once the battery 600′ i.e. fully charged is mounted into the battery bay, each of the pair of arms 50 are toggled from the upward configuration 42 to the downward configuration 44. This step occurs only when the current sensors provided in each of the pair of arms 50 sense zero current. In the next step, the platform 100a moves away from the vehicle 700.

In other embodiment, a method 2000c of swapping depleted battery 600 with recharged battery 600′ of a vehicle 700 using a manual platform 100c includes the following steps similar to that of the method 2000b. In the step of navigation of the platform 100c to the vehicle 700, the user pushes the platform 100c. Further, in the step of alignment of the platform 100c with the battery bay 750 of the vehicle 700, the user uses the plurality of mirrors 320 provided on the platform 100c for detecting positions of the alignment markers 310 for a precise alignment of the platform 100c. Further, the platform 100c implements a lifting mechanism 40b similar to the platform 100b. A hand pump replaces the power pack in the semi-automatic platform for toggling the pair of arms 50. The user has to move the hand pump in an up and down motion for toggling of each of the pair of arms 50 from an upward configuration 42 to a downward configuration 44 and vice versa for removal or mounting of the battery 600 or 600′ into the vehicle 700. Further, the user uses the plurality of mirrors 320 for determining the engagement of each of the pins 58 of each of the pair of arms 50 with each of the pair of slots 610 of the battery 600 or 600′.

The foregoing examples and illustrative implementations of various embodiments have been provided merely for explanation and are in no way to be construed as limiting of the embodiments disclosed herein. While the embodiments have been described with reference to various illustrative implementations, drawings, and techniques, it is understood that the words, which have been used herein, are words of description and illustration, rather than words of limitation. Furthermore, although the embodiments have been described herein with reference to particular means, materials, techniques, and implementations, the embodiments are not intended to be limited to the particulars disclosed herein; rather, the embodiments extend to all functionally equivalent structures, methods and uses, such as are within the scope of the appended claims. It will be understood by those skilled in the art, having the benefit of the teachings of this specification, that the embodiments disclosed herein are capable of modifications and other embodiments may be effected and changes may be made thereto, without departing from the scope of the embodiments disclosed herein.

1. A battery swapping system 500 for a vehicle 700, comprising:
at least a pair of slots 610 on a battery 600;
a plurality of alignment markers disposed onto a chassis of the vehicle 700;
a platform 100 having a depth d to receive the battery 600;
at least a pair of arms 50 disposed on the platform 100, wherein each arm 50 has a pin 58 for engaging with the pair of slots 610 of the battery;
a lifting mechanism 40 attached to each arm 50 to toggle between an upper configuration 42 and a downward configuration 44; and
a plurality of wheels 30 disposed on an outer surface of the platform 100,
wherein the platform 100 detects the plurality of alignment markers on the chassis of the vehicle 700, allowing the alignment with a battery bay 750 for swapping of the battery 500; and
wherein each pin 58 of at least the pair of arms 50 engages with at least the pair of slots 610 of the battery 600, and at least the pair of arms 50 toggle between the upper configuration 42 and the downward configuration 44 using the lifting mechanism 40, allowing the battery 600 to move either towards or away from a battery bay 750 of a vehicle 700.

2. The battery swapping system 500 as claimed in claim 1, wherein the pair of slots 610 includes each slot 610 provided along each of longitudinal side 604 of the battery 600.

3. The battery swapping system 500 as claimed in claim 1, wherein the battery swapping system 500 comprises a plurality of alignment markers 310.

4. The battery swapping system 500 as claimed in claim 1, wherein the pair of arm 50 includes each arm 50 disposed on a first inner wall 12′ and a second inner wall 13′, along a length l of the platform 100.

5. The battery swapping system 500 as claimed in claim 1, wherein each arm 50 has a fixed end 52 attached to the lifting mechanism 40 and a free end 54 thereof has the pin 58.

6. The battery swapping system 500 as claimed in claim 1, wherein the pair of arms 50 has a fixed gap 56 allowing a free movement of each of the arm 50.

7. The battery swapping system 500 as claimed in claim 1, wherein the lifting mechanism 40 for the at least one arm 50 is selected from any one of a hydraulic cylinder, an electric actuator, a servo motor and a linkage mechanism.

8. The battery swapping system 500 as claimed in claim 1, wherein the plurality of wheels 30 is omni-directional for complex maneuvers in limited space and eliminates dedicated pathways.

9. The battery swapping system 500 as claimed in claim 8, wherein the plurality of wheels 30 are disposed on the outer surface of the platform 100.

10. The battery swapping system 500 as claimed in claim 1, wherein the platform 100a is automatic and comprises:
a plurality of camera 315 disposed onto the platform 100a to detect the plurality of alignment markers 310 for an alignment of platform 100a along the battery bay 750;
a positioning system 400 provided in the platform 100a connected to a central server 450 located remotely to detect a position of the vehicle 700;
an ultrasonic proximity sensor 320 disposed on the platform 100 to detect hurdles in a path of movement of the platform 100a;
an encoder 51 disposed on each of the pair of arms 50 for detection of weight;
a servo motor connected to each of the plurality of wheels 30; and
a power pack to provide power to the platform 100a.

11. The battery swapping system 500 as claimed in claim 10, wherein the positioning system 400 in the platform 100a comprises one or more of a global positioning system (GPS) technology, a Bluetooth technology, a Wi-Fi technology, an ultra-wideband (UWB) communication technology, an indoor positioning system, and a RFID technology for navigation of the platform 100a on locating a position of the vehicle 700.

12. The battery swapping system 500 as claimed in claim 10, wherein the plurality of camera 315 comprises four cameras 315a-d, disposed on a top surface 102 of the platform 100a.

13. The battery swapping system 500 as claimed in claim 10, wherein the plurality of camera 315a-d has a view angle of at least 160 degrees.

14. The battery swapping system 500 as claimed in claim 1, wherein the platform 100b is semi-automatic and comprises:
a rod 115 having a screen 105 with a control panel 110 at its first end;
a handle 120 attached to the rod 115 along its length to maneuver the platform 100b;
a plurality of camera 315 disposed on a top surface 102 of the platform 100b;
a servo motor 31 provided to each of the plurality of wheels 30; and
a current sensor 53 disposed on each of at least one pair of arms 50, each of the current sensor 53 allows the system 500 to sense engagement and disengagement of the pin 58 with the plurality of slots 610 as a function of change in current.

15. The battery swapping system 500 as claimed in claim 14, wherein the rod 115 through its other end is attached to the platform 100, wherein the attachment is selected from reversible and permanent attachment.

16. The battery swapping system 500 as claimed in claim 1, wherein the platform 100c is manual and comprises:
a handle 120 attached to the platform 100c;
a plurality of mirror disposed on a top surface 102 of the platform 100; and
a hand pump 125 attached to the lifting mechanism 40c to toggle at least one pair of arms 50 between the upward configuration 42 and the downward configuration 44.

17. A method 2000 for replacing a discharged battery 600 with a charged battery 600′ in a vehicle 700 using the battery swapping system 500 as claimed in claim 1, comprising the steps of:
identifying the vehicle 700 by the system 500;
navigating the platform 100 to the vehicle 700;
aligning the platform 100 under the vehicle 700;
moving the plurality of arms 50 from the downward configuration 44 to the upward configuration 42 of the platform 100;
removing the battery 600 from the battery bay 750 of the vehicle 700;
identifying the vehicle 700 by a second platform 100′ having a battery 600′ fully charged using the unique code;
navigating the second platform 100′ having the battery 600′ fully charged to the vehicle 700;
aligning the second platform 100′ with the bottom chassis 760 of the vehicle 700;
lifting the battery 600′ fully charged from the second platform 100′ towards the battery bay 750 using the plurality of arm 50 of the platform 100′; and
mounting the battery 600′ fully charged with the battery bay 750 of the vehicle 700.

18. The method as claimed in claim 17, wherein the step of removing the battery 600 from the battery bay 750 of the electric vehicle 700 comprises an engagement of each pin 58 of the plurality of pair of arms 50 with each pair of the plurality of slots 610 on the battery 600 by toggling of each of two pair of arms 50 from the downward configuration 44 to the upward configuration 42 using the lifting mechanism 40.

19. The method as claimed in claim 18, wherein the step of removing the battery 600 from the battery bay 750 of the electric vehicle 700 comprises removal of a plurality of nuts and a plurality of bolts and further supporting the battery 600 with each of the plurality of arms 50 in the upward configuration 42.

20. The method as claimed in claim 18, wherein the step of removing the battery 600 from the battery bay 750 of the electric vehicle 700 comprises placing the battery 600 into the depth d of the platform 100 achieved by a movement of each of the pair of arms 50 from the upward configuration 42 to the downward configuration 44 using the lifting mechanism 40.

21. The method as claimed in claim 17, wherein the step of lifting the battery 600′ comprises an engagement of a plurality of slot 610 of the battery 600′ with each pin 58 of each of the pair of arms 50 of the second platform 100′ and a movement of each of the pair of arms 50 from the downward configuration 44 to the upward configuration 42 along with the battery 600.

22. The method of replacing a discharged battery 600 with a charged battery 600′ in a vehicle 700 using the battery swapping system 500 as claimed in claim 10, comprising the steps of:
providing a unique code through a central server 300 of a battery swapping system 500 to the vehicle 700;
navigating the platform 100a using a positioning system 400 and a plurality of ultrasonic proximity sensor 320 to the vehicle 700, wherein the plurality of ultrasonic proximity sensors 320 detects various hurdles in the path during navigation;
aligning the platform 100 using a plurality of camera by detecting the plurality of alignment marker 310 under the vehicle 700;
moving at least one pair of arm 50 using (x) from the downward configuration 44 to the upward configuration 42 of the platform 100, thus engaging each of the pin 58 of at least one pair of arm 50 with the at least one pair of slots 610 of the battery 600;
moving at least one pair of arm 50 along the battery 600 from the upward configuration 42 to the downward configuration 44, thus placing a discharged or a partially discharged battery 600 into the depth d of the platform 100 of the system 500;
navigating the platform 100 with a battery 600′ fully charged in the depth d, through the unique identification code using the positioning system and the plurality of ultrasonic proximity sensors 320 to the vehicle 700;
aligning the platform 100 using the plurality of camera by detecting the plurality of alignment marker 310 under the vehicle 700;
lifting the battery 600′ fully charged from the depth d of the platform 100 towards the battery bay 750 of the vehicle 700; and
mounting the battery 600′ fully charged with the battery bay 750 of the vehicle 700.

23. The method of replacing a discharged battery 600 with a charged battery 600′ in a vehicle 700 using a battery swapping system 500 as claimed in claim 14, with a semi-automatic platform 100b, comprising the steps of:
providing a unique code to the vehicle 700;
navigating the platform 100b to the vehicle 700 by a user by the handle 120 attached to the rod;
aligning the platform 100b using a plurality of camera by detecting the plurality of alignment marker 310 under the vehicle 700 by the user using the screen 105 with the control panel 110 for adjusting the platform 100b;
moving at least one pair of arms 50 using (x) from the downward configuration 44 to the upward configuration 42 of the platform 100b, thus engaging each of the pin 58 of at least one pair of arms 50 with the at least one pair of slots 610 of the battery 600 by the user;
moving at least a pair of arms 50 along the battery 600 from the upward configuration 42 to the downward configuration 44, thus placing a discharged or a partially discharged battery 600 into the depth d of the platform 100b of the system 500 by the user;
navigating the platform 100b with a battery 600′ fully charged in the depth d, by a user using the handle 120 attached to the rod 115;
aligning the platform 100b using the plurality of camera 315 by detecting the plurality of alignment marker 310 under the vehicle 700 by the user using the screen 105 with the control panel 110 for adjusting the platform 100b;
lifting the battery 600′ fully charged from the depth d of the platform 100b towards the battery bay 750 of the vehicle 700 by the user with the control panel 110; and
mounting the battery 600′ fully charged in the battery bay 750 of the vehicle 700.

24. The method as claimed in claim 23, wherein the steps of engagement and the step of lifting using the lifting mechanism 40b comprises each of the pair of arms 50 connected to a link through a shaft, each link is further connected to a hydraulic cylinder in turn connected a common pipe and a power pack.

25. The method as claimed in claim 23, wherein the step of navigating the platform 100b comprises pressing a button 111 on the control panel 110 on the platform 100b by the user and further, the user holding the handle 120 towards the vehicle 700.

26. The method as claimed in claim 23, wherein the steps of aligning the platform 100b comprises a visual stream on the screen 105 provided by the plurality of cameras 315a-d allowing the user to adjust and align the platform 100b with respect to the plurality of alignment markers 310.

27. The method as claimed in claim 23, wherein the steps of engagement and the step of lifting using the lifting mechanism 40c comprises each of the pair of arms 50 connected to a link through a shaft, each link being further connected to a hydraulic cylinder in turn connected to a common pipe and a hand-pump 125.

28. The method as claimed in claim 23, wherein the step of navigating the platform 100c comprises pushing of the platform 100c by the user using the handle 120 towards the vehicle 700.
